(19) United States
(12) Patent Application Publication
(10) Pub. No.: US 2015/0142912 A1
(43) Pub. Date: May 21, 2015

(54) SYSTEM AND METHOD FOR PROVIDING ISOLATION BOUNDARIES BETWEEN REGULATED MEDICAL APPLICATIONS AND UNREGULATED, NON-MEDICAL APPLICATIONS

(71) Applicant: Intel-GE Care Innovations LLC, Roseville, CA (US)

(72) Inventors: Kevin Hebert, Roseville, CA (US); Jason Smith, Roseville, CA (US); Jesjit Birak, Roseville, CA (US)

(73) Assignee: Intel-GE Care Innovations LLC, Roseville, CA (US)

(21) Appl. No.: 14/083,844

(22) Filed: Nov. 19, 2013

(51) Int. Cl. H04L 29/08

(52) U.S. Cl. CPC H04L 67/10; H04L 67/32
USPC 709/217

(57) ABSTRACT

The disclosure relates to systems and methods for providing isolation boundaries between regulated medical applications and unregulated, non-medical applications, allowing the regulated medical applications and unregulated, non-medical applications co-exist on a common web platform. The regulated medical applications and unregulated, non-medical application may be assigned to different application pools separated by the isolation boundaries. For example, a regulated medical application may be assigned to a first application pool and an unregulated, non-medical application may be assigned to a second application pool. A request directed to the regulated medical application may be received. The request may comprise instructions for causing the application to perform one or more functions. The request may be processed by a worker process associated with the first application pool such that the request can be processed independently of or separately from the second application pool.

### FIELD OF THE INVENTION

The disclosure relates to systems and methods for providing isolation boundaries between regulated medical applications and unregulated, non-medical applications, allowing the regulated medical applications and unregulated, non-medical applications co-exist on a common web platform.

### BACKGROUND OF THE INVENTION

Traditionally, if a software device has one or more components that are subject to regulations by a governing agency, then the entire software device must obtain regulatory clearance from the governing agency. This approach requires the manufacturer and the developers of the software to integrate both regulated and non-regulated software components together as an embedded system in order to obtain the appropriate clearance for the entire system, regardless of the marketing claims or intended use of the system.

As such, what is needed is to be capable of designing and deploying regulated and non-regulated software on a common platform without having to file for regulatory clearance on the entire platform. These and other problems exist.

### SUMMARY OF THE INVENTION

One aspect of the disclosure relates to systems and methods for providing isolation boundaries between regulated medical applications and unregulated, non-medical applications, allowing the regulated medical applications and unregulated, non-medical applications co-exist on a common web platform.

The regulated medical applications and unregulated, non-medical application may be assigned to different application pools separated by the isolation boundaries. For example, a regulated medical application may be assigned to a first application pool and an unregulated, non-medical application may be assigned to a second application pool. A request directed to the regulated medical application may be received. The request may comprise instructions for causing the application to perform one or more functions. The request may be processed by a worker process associated with the first application pool such that the request can be processed independently of or separately from the second application pool.

In one embodiment, there is provided a web server, comprising: a plurality of applications hosted by the web server, the plurality of applications comprising one or more medical applications that are regulated by a governing agency and one or more non-medical applications that are not regulated by the governing agency, the plurality of applications grouped into a plurality of application pools that is separated by isolation boundaries between application pools such that a first application in a first application pool of the plurality of application pools runs independently of and separately from a second application in a second application pool of the plurality of application pools; a request handling module configured to: receive a request directed to at least one application of the plurality of applications; and identify an application pool associated with the at least one application to which the request was made; and a request processing module configured to: process the request within the identified application pool such that the request is processed independently of and separately from other application pools of the plurality of application pools.

In another embodiments, there is provided a non-transitory computer readable medium storing computer-readable instructions that, when executed by one or more processors, cause a computer to: receive, by a request handling module, a request directed to a medical application that is regulated by a governing agency, wherein the regulated medical application is associated with the first application pool and a non-medical application that is not regulated by the governing agency is associated with a second application pool, the first and second application pools separated by an isolation boundary; identify, by the request handling module, a first application pool associated with the regulated medical application; and process, by a request processing module, the request within the first application pool such that the request is processed independently of or separately from the second application pool.

In another embodiments, there is provided a method implemented in a computer that includes one or more processors configured to execute one or more computer program instructions, the method comprising: creating a first application pool and a second application pool, wherein the first and second application pools are separated by an isolation boundary such that applications in the first application pool run independently of and separately from applications in the second application pool; creating an association between a regulated medical application and the first application pool; creating an association between a unregulated, non-medical application and the second application; and storing the associations in a data storage.

Other objects and advantages of the invention will be apparent to those skilled in the art based on the following drawings and detailed description. It also is to be understood that both the foregoing general description and the following detailed description are exemplary and not restrictive of the scope of the embodiments.

### BRIEF DESCRIPTION OF THE DRAWINGS

FIG. 1 illustrates a system for providing isolation boundaries between regulated medical applications and unregulated, non-medical applications, according to an aspect of the invention.

FIG. 2 illustrates a process for processing a request directed to a regulated medical application independently of and separately from an unregulated, non-medical application using application pools separated by isolation boundaries, according to an aspect of the invention.

FIG. 3 illustrates a plurality of application pools that are separated by isolation boundaries, according to an aspect of the invention.

### DETAILED DESCRIPTION OF THE INVENTION

One aspect of the disclosure relates to systems and methods for providing isolation boundaries between regulated medical applications and unregulated, non-medical applications, allowing the regulated medical applications and unregulated, non-medical applications co-exist on a common web platform. The regulated medical applications and unregulated, non-medical application may be assigned to different application pools separated by the isolation boundaries. For example, a regulated medical application may be assigned to a first application pool and an unregulated, non-medical application may be assigned to a second application pool. A request directed to the regulated medical application may be received. The request may comprise instructions for causing the application to perform one or more functions. The request may be processed by a worker process associated with the first application pool such that the request can be processed independently of or separately from the second application pool.

As used herein, “regulated medical applications” (used interchangeably with “regulated applications”) may comprise one or more medical applications that are regulated by a governing agency. For example, in the United States, the U.S. Food and Drug Administration (FDA) is responsible for regulating medical devices sold in the United States based on certain regulatory requirements. There regulatory requirements must be met before a medical device can be marketed in the United States. A regulated medical application comprises application code that is developed and cleared for use by a governing agency (e.g., FDA) for commercial availability based on its intended use. Other applications that are not subject to such regulatory requirements may be designated as “unregulated, non-medical applications.”

As used herein, an “application pool” may comprise a group of one or more applications (e.g., web applications, webpages or websites provided by the web applications, URLs (uniform resource locator), etc.) that are served by a worker process (or a set of worker processes). Applications pools may be separated by isolation boundaries (used interchangeably with “process boundaries”) between them such that a first application in a first application pool runs independently of and separately from a second application in a second application pool. As such, applications pools provide a convenient way to isolate one or more applications from other applications on the same server computer.

As used herein, a “worker process” may be configured to process and/or handle requests that are made and/or directed to one or more applications that are assigned to and/or associated with a particular application pool. Every application within an application pool, therefore, shares the same worker process (or the same set of worker processes). For example, the worker process may include a windows process (w3wp.exe) that is responsible for running web applications and/or servicing requests made to a specific application pool. As such, the worker process that is associated with one application pool is separated and isolated from the worker process that is associated with another.

Other implementations and uses of the system will be apparent based on the disclosure herein. Having provided a broad overview of a use of the system, various system components will now be described.

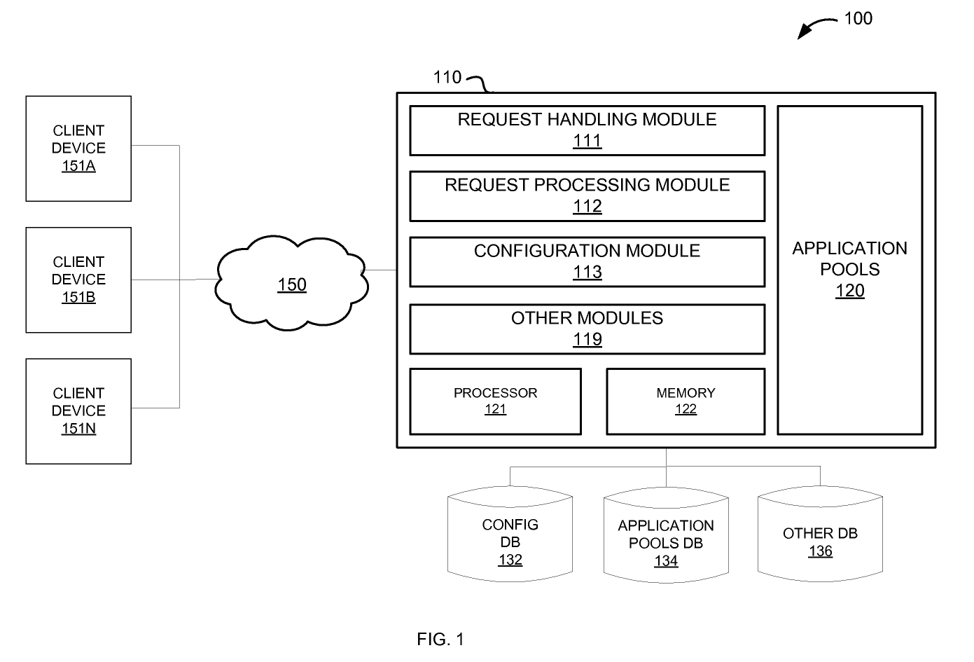

FIG. 1 illustrates a system 100 for providing isolation boundaries between regulated medical applications and unregulated, non-medical applications, according to an aspect of the invention. In some embodiments, system 100 may include a server 110, client devices (illustrated in FIG. 1 as client devices 151A, 151B, . . . , 151N), a network 150, and/or other components.

Server 110 may comprise a web server having one or more web applications that may be accessed by client devices 151 via a communication network such as the Internet using a web browser. In some embodiments, each web application may be implemented as an applet. An applet is a set of features providing a cohesive set of functionality. In order to provide as much modularity and isolation as possible, all of the code required to implement an applet may be contained in separate deployment files. This will make it easier to add or update an applet after initial deployment. Each applet configured as a separate web application may be configured to run in a separate application pool. This may ensure that each applet runs in its own worker process, isolating it from other applets, memory and runtime processes.

In some embodiments, one or more applets may include, for example, a portal applet (e.g., displaying public pages, registering users, authenticating users, resetting passwords, managing user profiles, managing workspaces, managing permissions for users, etc.), a calendar and notification applet (e.g., creating, receiving, viewing, and/or managing calendar events, assigning participants to the calendar event, generating and/or sending alerts/notifications, etc.), contacts applet (e.g., entering, editing, viewing, and deleting contacts), a measurements applet (e.g., capturing and/or obtaining vital sign measurements from one or more medical peripheral devices), a health assessments applet (e.g., creating, viewing, and/or managing a health session during which various health measurements may be taken and health assessments may be conducted, accessing a session summary and/or detailed session history, creating, sending, and/or managing reminders for the health session, requesting protected health information (PHI) view, etc.), a medications applet (e.g., creating, editing, and deleting medications, setting calendar reminders for medications and tasks for medication refills), a workspace/account manager applet (e.g., creating personal or group workspace for use by registered users, managing user accounts, profiles, workspace membership, access permissions, etc.), a learn more applet (e.g., accessing clinical content) and/or other applets.

In some embodiments, server 110 may include a plurality of hardware, software, and/or firmware components operating together to provide the functionality attributed herein to server 110. For example, server 110 may be implemented by a cloud of computing platforms operating together as server 110. The cloud-based server 110 may run in a public cloud, a private cloud, and/or a hybrid cloud. The cloud-based server 110 may have the one or more web applications running in a cloud environment.

In some embodiments, server 110 may include one or more computers programmed to execute computer program modules. Through these program modules, server 110 may receive a request directed to a regulated medical application, identify an application pool associated with the regulated medical application to which the request was made, and process the request within the identified application pool such that the request is processed independently of and separately from other unregulated, non-medical application assigned to other application pools.

For example, server 110 may include a request handling module 111, a request processing module 112, a configuration module 113, and/or other modules 119 for performing the functions described herein.

In some embodiments, a plurality of application (e.g., web applications) hosted by server 110 may comprise one or more regulated medical applications and one or more non-medical application that are not regulated by the governing agency. For example, the one or more regulated medical applications may include the measurements applet and the health assessment applet that may process (and/or store) protected health information (PHI) and/or other information and/or perform various functionalities that may be subject to regulatory requirements imposed by a governing agency. In this example, the measurements applet may take, enter, and/or store vitals data of a patient in a database within the application pool to which the measurements applet is assigned. The health assessment applet may allow a patient to take health assessments and/or store the assessments data and history in a database within the application pool to which the health assessment applet is assigned. Other types of applets such as the calendar applet and the contacts applet that are not subject to such regulatory requirements may not require regulatory clearance before making them commercially available.

The plurality of applications may be grouped into a plurality of application pools 120 that may be separated by isolation boundaries between application pools. In this way, a first application in a first application pool of the plurality of application pools may run independently of and separately from a second application in a second application pool of the plurality of application pools. For example, one or more regulated medical applications such as the measurements applet may be isolated from other unregulated, non-medical applications such as the contacts applet by assigning them to different application pools. In this example, a given application pool would not be allowed to have both regulated medical applications and unregulated, non-medical applications. Through this application process isolation, developers and manufacturers can design and deploy regulated and non-regulated software on a web platform without having to file for regulatory clearance on the entire web platform.

In some embodiments, request handling module 111 may be configured to receive and/or obtain a request made and/or directed to at least one application of the plurality of applications hosted by server 110. The request may comprise instructions for causing the application to perform one or more functions. For example, the request may include a request to create calendar reminders using the calendar applet, a request to take or view measurements using the measurements applet, a request to take health assessments using the assessments applet, and so on.

In some embodiments, request handling module 111 may identify an application pool associated with the application to which the request was made. Associations between one or more applications and one or more application pools may be specified automatically by the system or manually based on user input. An application may be selected and associated with a newly created or pre-existing application pool. The specified associations may be stored in a configuration database 132 and/or other databases 136. In some embodiments, request handling module 111 may identify the application pool associated with the application to which the request was made based on the pre-configured and/or stored association between them.

In some embodiments, when a plurality of requests is made to the identified application pool, request handling module 111 may be configured to create a request queue for the identified application pool. The request queue may arrange the plurality of requests in the order the requests are received. Request handling module 111 may process and/or service the plurality of requests from the request queue in the order they are received. In some embodiments, the plurality of requests may be made by the same user or by different users. For example, when User A selects to measure his/her blood pressure measurement and User B subsequently selects to view his/her measurement history, a request queue comprising the two requests from User A and User B may be created. The requests in the request queue may be serviced by one or more worker processes associated with the measurements applet.

In some embodiments, the one or more worker processes may be launched once a request is made to an application in the identified application pool. In other embodiments, the one or more worker processes may be configured to start automatically whenever an application pool starts. This automatic start-up may be useful especially when there is a delay in starting the one or more worker processes. Request handling module 111 may be configured to determine whether the one or more worker processes associated with the identified application pool has been initiated and/or launched. If it is determined that the one or more worker processes are not running, request handling module 111 may initiate the one or more worker processes which may be used to process and/or service the request made to the identified application pool.

In some embodiments, request processing module 112 may be configured to process the request within the identified application pool. In this way, the request may be processed within the identified application pool independently of and separately from other application pools of the plurality of application pools.

In some embodiments, application code, data cache, services (e.g., web application services), and/or databases associated with applications assigned to an application pool may be contained within the same application pool. In this way, each application pool can exist as a separate and independent entity. Application pools separated by isolation boundaries help ensure that problems and errors made in one application pool do not affect applications in other application pools. Moreover, data related to an application in one application pool can be protected from users accessing applications in other application pools.

In some embodiments, in response to a request made to a particular application and its associated application pool, which may require the application to access certain data, request processing module 112 may initially attempt to read the data from the cache within the application pool. When the data is not in the cache, or when the application needs to insert, update, or delete the data, request processing module 112 may call one of the web services from the application pool. The web service may then read, insert, update, and/or delete data from the database in the application pool. Any changes made to the database may trigger the web service to update the cache to reflect those changes. In some embodiments, confidential data such as personal health information (PHI), personal identity information (PII), or the likes may not be cached at the cache level and can only be accessed by accessing the database.

In some embodiments, request processing module 112 may be configured to generate a response to the request based on the processing of the request. The response may include, for example, data requested by the request, an indication of an error that occurred during the processing, an indication of a completion of the processing, and/or other responses. For example, if a user made a request to view his/her past measurements data (e.g., PHI data) with the measurements applet, request processing module 112 may process the request by calling a web service to read the measurements data from the database where both the web service and the database are associated with the application pool to which the measurements applet is assigned.

In some embodiments, configuration module 113 may be configured to maintain associations between one or more applications and one or more application pools. In some embodiments, configuration module 113 may receive a user input defining an association between an application and an application pool. For example, a user (e.g., a system administrator) may create an application pool for one or more regulated medical applications and assign the measurements applet to the created application pool. In another example, another application pool may be created for one or more unregulated, non-medical applications, to which the user may assign the contacts applet. The associations specified and/or defined in this manner may be stored in configuration database 132 and/or other databases 136.

Other uses and implementations of server 110 will be apparent to those having skill in the art based on the disclosure herein. Having provided an overview of implementations and components of server 110, various other components of system 100 will now be described.

In some embodiments, server 110 may include or otherwise access various databases to store and/or retrieve information. The various databases may include, for example, configuration database 132, application pools database 134, and/or other databases 136. Configuration database 132 may store associations between one or more applications and one or more application pools. Application pools database 132 may store application code, data cache, services, and/or databases separated by isolation boundaries between application pools.

In some embodiments, client devices 151 may each be or may include a mobile device, one or more computing devices (e.g., specialty computing systems, desktop computers, personal computers, mobile computing devices, tablet computing devices, smart-phones, or other computing devices) having one or more processors (e.g., microprocessors), memory devices (e.g., hard disk, RAM, EEPROM, etc.), input/output components, and/or other computing components for performing the features and functions described herein (and/or other features and functions). Each of the foregoing devices may have one or more user interfaces such as a keypad, a display, a voice recognition microphone and speaker to interact with a user. In some embodiments, each of the foregoing devices comprises a processor coupled to a memory over a bus to carry out the features and functionalities of the embodiments described herein. In some embodiments, each of the foregoing devices comprises one or more computer program modules residing in the memory thereof and generating a display that is displayed to the user via the display. Each of the foregoing devices may have an antenna to wirelessly communicate with other components of system 100 over network 150 or independent of network 150.

In some embodiments, network 150 may be or include a communications network capable of supporting one or more modes of communications, including but not limited to, wireless, wired, and optical communications. For example, network 150 may comprise cell phone towers or other wireless communication infrastructure, public switched telephone networks (PSTN), active and passive optical networks, and combinations thereof. Examples of such networks may include computer implemented networks such as the Internet, a local area network (LAN), a wide area network (WAN), etc.

The databases 132, 134, 136, and/or other data storages described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Standard Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

The foregoing description of the various components comprising system 100 is exemplary only, and should not be viewed as limiting. The invention described herein may work with various system configurations. Accordingly, more or less of the aforementioned system components may be used and/or combined in various implementations.

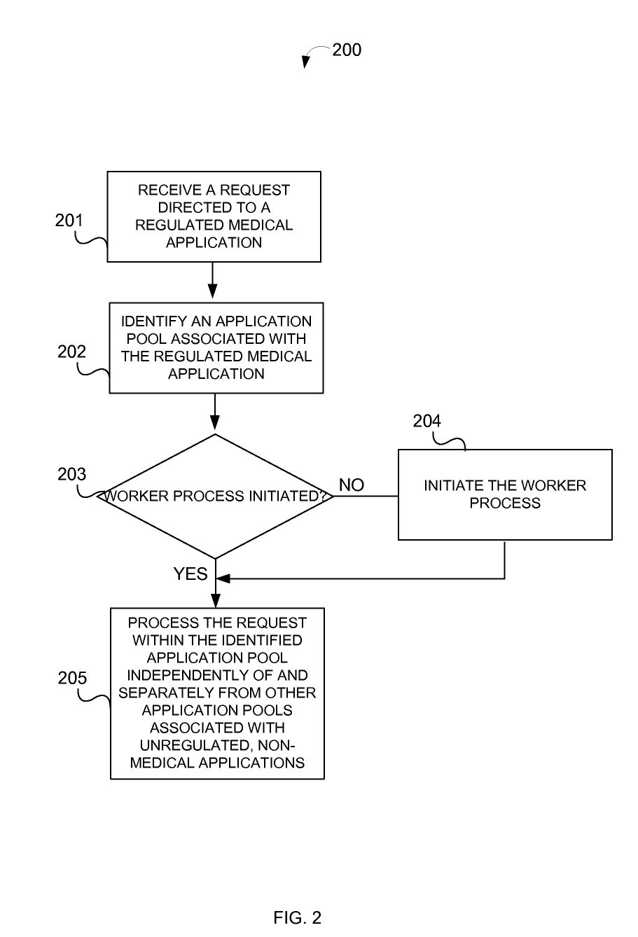

FIG. 2 illustrates a process 200 for processing a request directed to a regulated medical application independently of and separately from an unregulated, non-medical application using application pools separated by isolation boundaries, according to an aspect of the invention. The various processing operations and/or data flows depicted in FIG. 2 (and in the other drawing Figures) are described in greater detail herein. The described operations may be accomplished using some or all of the system components described in detail above and, in some embodiments, various operations may be performed in different sequences. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 201, process 200 may include receiving a request made and/or directed to a regulated medical application hosted by server 110. The request may include, for example, a request to take or view measurements using the measurements applet, a request to take health assessments using the assessments applet, etc.

In an operation 202, process 200 may include identifying an application pool associated with the regulated medical application to which the request was made. In some embodiments, the identification may be based on predetermined associations between them. For example, the associations may be specified and/or defined automatically by the system or manually by user input. The specified associations may be stored in a configuration database 132 and/or other databases 136.

In an operation 203, process 200 may include determining whether one or more worker processes associated with the identified application pool has been initiated and/or launched. If it is determined that the one or more worker processes are not running, process 200 may proceed to an operation 204. In operation 204, process 200 may include initiating the one or more worker processes which may be used to process and/or service the request made to the regulated medical application.

However, if the one or more worker processes have already started and/or is running, process 200 may proceed to an operation 205. In operation 205, process 200 may include processing the request within the identified application pool such that the request is processed independently of and separately from other application pools associated with unregulated, non-medical applications.

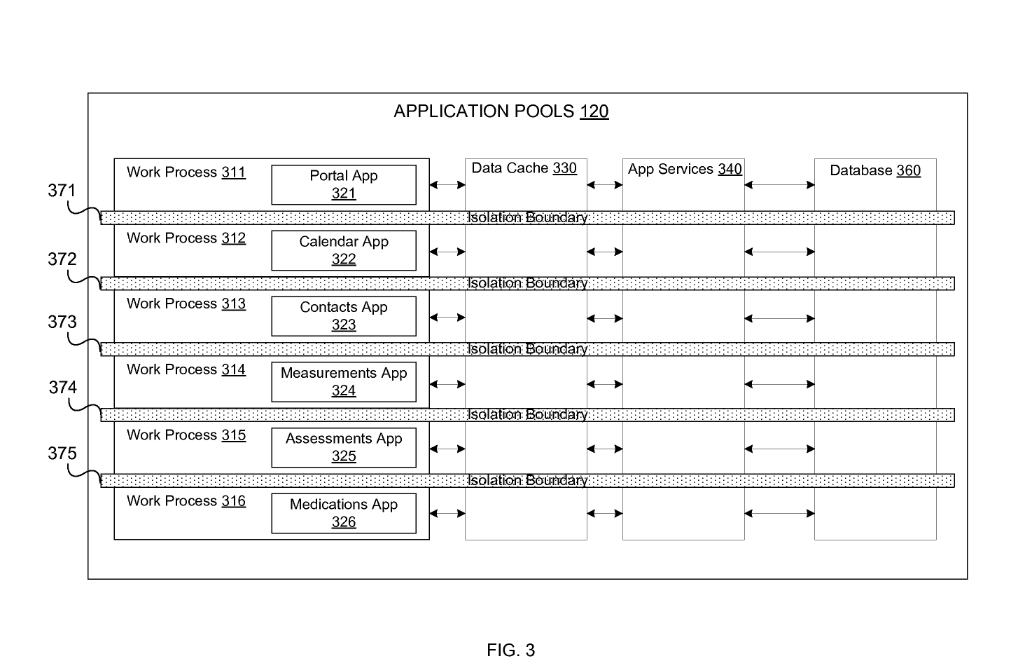

FIG. 3 illustrates a plurality of application pools that are separated by isolation boundaries, according to an aspect of the invention.

A plurality of web applications hosted by server 110 may comprise one or more regulated medical applications and one or more unregulated, on-medical applications. For example, the one or more regulated medical applications may include measurements applet 324 and assessments applet 325 that may process (and/or store) protected health information (PHI) and/or other information and/or perform various functionalities that may be subject to regulatory requirements imposed by a governing agency. Other types of applets such as portal applet 321, calendar applet 322, contacts applet 323, and medications applet 326 that are not subject to such regulatory requirements may be classified as unregulated, non-medical applications.

The applications 321-326 may be grouped in a plurality of application pools 120 that may be separated by isolation boundaries (illustrated in FIG. 3 as isolation boundaries 371-375) between the application pools 120. In this way, a regulated medical application such as measurements applet 324 may be isolated from other unregulated, non-medical applications such as calendar applet 322 by assigning them to different application pools. Through this application process isolation, developers and manufacturers can design and deploy regulated and non-regulated software on a web platform (e.g., server 110) without having to file for regulated clearance on the entire platform.

Each of the plurality of application pools 120 may be serviced by a corresponding worker process (or a corresponding set of worker processes) (illustrated in FIG. 3 as worker processes 311-316). For example, worker process 314 may be configured to process and/or handle requests that are made and/or directed to measurements applet 324. If there are more than one applications assigned to a given application pool, those applications may share the same worker process (or the same set of worker processes) associated with the given application pool.

In some embodiments, application code (not shown in FIG. 3), data cache 330, services 340, and/or databases 360 associated with applications assigned to a particular application pool may be contained within the same application pool. In this way, each application pool can exist as a separate and independent entity.

In some embodiments, in response to a request made to a particular application and its associated application pool, which may require the application to access certain data, request processing module 112 may initially attempt to read the data from the cache 330 within the application pool. When the data is not in the cache 330, or when the application needs to insert, update, or delete the data, request processing module 112 may call one of the web services 340 from the application pool. The web service may then read, insert, update, and/or delete data from the database 360 in the application pool. Any changes made to the database 360 may trigger the web service 340 to update the cache 330 to reflect those changes. In some embodiments, confidential data such as personal health information (PHI), personal identity information (PII), or the likes may not be cached at the cache level 330 and can only be accessed by accessing the database 360. For example, if a user made a request to view his/her past measurements data (e.g., PHI data) with measurements applet 324, request processing module 112 may process the request by calling a web service 340 to read the measurements data from the database 360 where both the web service 340 and the database 360 are associated with the application pool to which the measurements applet is assigned.

In the Figures, like numerals represent equivalent elements or features. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A web server, comprising:
a plurality of applications hosted by the web server, the plurality of applications comprising one or more medical applications that are regulated by a governing agency and one or more non-medical applications that are not regulated by the governing agency, the plurality of applications grouped into a plurality of application pools that is separated by isolation boundaries between application pools such that a first application in a first application pool of the plurality of application pools runs independently of and separately from a second application in a second application pool of the plurality of application pools;
a request handling module configured to:
receive a request directed to at least one application of the plurality of applications; and
identify an application pool associated with the at least one application to which the request was made; and
a request processing module configured to:
process the request within the identified application pool such that the request is processed independently of and separately from other application pools of the plurality of application pools.

2. The web server of claim 1, wherein one or more application pools that include the one or more medical applications that are regulated by the governing agency are different from one or more application pools that include the one or more non-medical applications that are not regulated by the governing agency.

3. The web server of claim 1, wherein the one or more medical applications that are regulated by the governing agency comprises application code that is developed and cleared for use by the governing agency.

4. The web server of claim 1, the request processing module configured to generate a response to the request based on the processing of the request.

5. The web server of claim 1, wherein each of the plurality of application pools includes application code, services, and data associated with an application that is associated with the each of the plurality of application pools.

6. The web server of claim 1, the request handling module further configured to create a request queue for the identified application pool when a plurality of requests is made to the identified application pool; and the request processing module further configured to process the plurality of requests from the request queue in the order the plurality of requests is received.

7. The web server of claim 1, the web server further comprising:
a configuration database configured to store associations between the plurality of applications and the plurality of application pools.

8. The web server of claim 7, the web server further comprising:
a configuration module configured to:
receive a user input defining an association between an application and an application pool; and
store the association between the application and the application pool in the configuration database.

9. The web server of claim 7, wherein identifying the application pool associated with the at least one application comprises retrieving the stored association from the configuration database and identifying the application pool associated with the at least one application based on the stored association.

10. The web server of claim 1, wherein each of the plurality of application pools is associated with a worker process that processes a request that was made to an application associated with the each of the plurality of application pools.

11. The web server of claim 10, the request handling module further configured to:
determine whether the worker process associated with the identified application pool has been initiated; and
initiate the worker process based on determining that the worker process has not been initiated.

12. A non-transitory computer readable medium storing computer-readable instructions that, when executed by one or more processors, cause a computer to:
receive, by a request handling module, a request directed to a medical application that is regulated by a governing agency, wherein the regulated medical application is associated with a first application pool and a non-medical application that is not regulated by the governing agency is associated with a second application pool, the first and second application pools separated by an isolation boundary;
identify, by the request handling module, the first application pool associated with the regulated medical application; and
process, by a request processing module, the request within the first application pool such that the request is processed independently of or separately from the second application pool.

13. The non-transitory computer readable medium of claim 12, wherein the regulated medical application comprises application code that is developed and cleared for use by the governing agency.

14. The non-transitory computer readable medium of claim 12, wherein the first application pool is serviced by a worker process that is different from a worker process that services the second application pool.

15. The non-transitory computer readable medium of claim 14, further causing the computer to:
determine, by the request handling module, whether the worker process associated with the first application pool has been initiated; and
initiate the worker process based on determining that the worker process has not been initiated.

16. A method implemented in a computer that includes one or more processors configured to execute one or more computer program instructions, the method comprising:
creating a first application pool and a second application pool, wherein the first and second application pools are separated by an isolation boundary such that applications in the first application pool run independently of and separately from applications in the second application pool;
creating an association between a regulated medical application and the first application pool;
creating an association between a unregulated, non-medical application and the second application; and
storing the associations in a data storage.

17. The method of claim 16, further comprising:
receiving a request directed to the regulated medical application;
identifying the first application pool based on the stored associations; and
processing the request within the first application pool.
